(19) United States
(12) Patent Application Publication
(10) Pub. No.: US 2006/0171670 A1
(43) Pub. Date: Aug. 3, 2006

(54) Recording and playback device with simple programmed recording method

(75) Inventor: Tomofumi Doi, Echizen-city (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: ORION ELECTRIC CO., LTD., Echizen-city (JP)

(21) Appl. No.: 11/335,465

(22) Filed: Jan. 20, 2006

(30) Foreign Application Priority Data
Jan. 31, 2005 (JP) 2005-024323

(51) Int. Cl. H04N 5/91

(52) U.S. Cl. 386/83

(57) ABSTRACT

To provide a recording and playback device with a simple programmed recording method which enables new programmed recording to be easily performed on a recording medium. A displayed recording title is selected under the control of a displaying unit, a recorded date and time, a recorded channel and the like included in a character string of recording title data is decoded and converted into numerals by a decoding unit, a program setting unit sets new programmed recording based on the converted numeral data, a remaining amount detecting unit detects a lack of a remaining amount for recording of a DVD disk, an informing unit informs this, and a control unit controls to change the medium from the DVD disk to a VTR tape and start recording.

The present application is based on and claims priority of Japanese patent application No. 2005-024323 filed on Jan. 31, 2005, the entire contents of which are hereby incorporated by reference.

### BACKGROUND OF THE INVENTION

1. Field of the Invention

The present invention relates to a recording and playback device that enables programmed recording, and more particularly, to a recording and playback device with a simple programmed recording method that enables programmed recording on a plurality of recording media.

2. Description of the Related Art

As one of the recording and playback devices which enable programmed recording is automatically set based on a program list supplied from the EPG (Electric Program Guide) or the like, Japanese Patent Laid-Open Publication No. 2003-46921 (patent document 1) has proposed “A method, device and program for programmed recording”. This conventional art proposes a method for realizing a program programmed recording device for recording a program automatically following a change of broadcast time by providing specification means for specifying a first recording title based on electronic program information on a recording title and a broadcasting time, detecting means for detecting a second recording title whose character string is partly the same as that of the first recording title and whose program is to be broadcast next time, information obtaining means for obtaining the broadcast time information on the program of the second recording title, and programmed recording means for programming a program of the second recording title so that the program will be recorded on a hard disk.

### SUMMARY OF THE INVENTION

The abovementioned conventional art, for example that described in the patent document 1, is a program programmed recording device with a programmed recording function for automatically following a change of broadcast time based on an electronic program list and start time and end time of program broadcasting information supplied from an electronic program list supplier and a broadcaster. In order to use this device, a user needs to obtain electronic program information. When a first recording medium is changed to a second recording medium, data on recording titles of programs recorded on the first recording medium cannot be ported to the second recording medium. Thus, a user needs to set programmed recording to the second recording medium. The conventional art also has a problem: If a first recording file is recorded on a first recording medium by a recording and playback device A, then the first recording medium is inserted in a recording and playback device B whose model is different from that of the recording and playback device A, it is not simple for a user to program the recording and playback device B for recording a second recording file to be broadcast in the following week on the first recording medium because the recording title is not common to both of the recording and playback devices A and B. The present invention intends to obtain a recording and playback device with a simple programmed recording method which can improve a viewer's usability by enabling the viewer to simply set programmed recording for the subsequent time with a recording title which is automatically created when ordinary recording or programmed recording ends for relieving the viewer to obtain electronic program information from the EPG or the like as mentioned above, allowing the viewer to omit programming of recording a program when a first recording medium is changed with a second recording medium, enabling the viewer to simply set programmed recording even when the viewer inserts a first recording medium in a recording and playback device B in order to record a second recording file for the subsequent week after recording a first recording file on the first recording medium by a recording and playback device A whose model is different from that of the recording and playback device B, and detecting and informing a remaining amount of the inserted recording medium to the viewer.

A recording and playback device with a simple programmed recording method of a first aspect is a recording and playback device which can receive airwaves, convert the airwaves into audio/video signals which can be displayed and display the audio/video signals on a display unit, convert the audio/video signals which can be displayed into audio/video data which can be recorded and played and record and replay the audio/video data on a recording medium by a recording and playback unit, wherein the recording and playback device creates a recording title and displays the recording title on the display unit, and sets programmed recording based on the displayed recording title and records a program by monitoring a broadcast time of the program corresponding to a programmed recording program set from the recording title, comprising a decoding unit for decoding date of recording, start time of recording, end time of recording, recorded channel, recording mode and the like included in a character string of a recording title from a recording file and the recording title of the broadcast program read out from the recording medium into a microcontroller provided in the recording and playback device and converting the date of recording, the start time of recording, the end time of recording, the recorded channel, the recording mode and the like into numerals, wherein a program setting unit provided in the microcontroller converts video of a recording title recorded on the recording medium and the recording title into numerals and sets new programmed recording.

According to a configuration of the first aspect, as the microcontroller has a decoding unit for decoding date of recording, start time of recording, end time of recording, recorded channel, recording mode and the like included in a character string of a recording title which was created by obtaining recording title data read by a recording and playback unit or program data such as the EPG and converting the date of recording, the start time of recording, the end time of recording, the recorded channel, the recording mode and the like into numerals, new programmed recording is set at the program setting unit by converting video by the recording file recorded on the recording medium when programming is performed and the displayed recording title into numerals. The recording and playback device can monitor time for the set programmed recording and record the program.

A recording and playback device with a simple programmed recording method of a second aspect is the recording and playback device with a simple programmed recording method according to the first aspect, wherein the decoding unit decodes data on rebroadcast program obtained from the EPG or the like and a character string of a recording title of the rebroadcast program and converts the data and the character string into numerals, wherein the programmed setting unit automatically records programs by setting programmed recording of a rebroadcast program based on each of the converted numerals, and wherein the program setting unit sorts recorded programs into an order the programs originally broadcast for playing a program which is missed being recorded in the order.

According to a configuration of the second aspect, data on rebroadcast program is obtained from program data such as the EPG by a data obtaining unit, recording title data of rebroadcast program is decoded and converted into numerals by a decoding unit, programmed recording for a rebroadcast program is set by a programmed setting unit so that the set rebroadcast program is automatically programmed by monitoring a rebroadcast time of the program, and the programs are sorted by the program setting unit into an order the programs originally broadcast for playing a program which is missed being record in the order.

A recording and playback device with a simple programmed recording method of a third aspect is the recording and playback device with a simple programmed recording method according to the first or the second aspect, wherein the microcontroller comprises a remaining amount detecting unit for calculating a remaining amount for recording of a current recording medium based on recording time data obtained from the program setting unit and an informing unit for informing a lack of the remaining amount for recording, wherein the lack of the remaining amount for recording is informed when the remaining amount for recording lacks.

According to a configuration of the third aspect, as the microcontroller has a remaining amount detecting unit for calculating a remaining amount for recording of a current recording medium based on recording time data obtained from a program setting unit and an informing unit for informing a lack of the remaining amount for recording, so that the lack of a remaining amount for recording is informed when the remaining amount for recording lacks.

A recording and playback device with a simple programmed recording method of a fourth aspect is the recording and playback device with a simple programmed recording method according to any one of the first to the third aspects, further comprising a plurality of recording and playback units, wherein if a remaining amount of a recording medium recorded at the recording and playback unit lacks, the recording medium is switched to any of the other recording media and recording is started, and the recording title and a new programmed recording program are ported to the other recording medium.

According to a configuration of the fourth aspect, the recording and playback device has a plurality of recording and playback units, and if a remaining amount of a recording medium recorded at the recording and playback unit lacks, the recording medium is switched to any of the other recording media and recording is started, and the recording title and a new programmed recording program are ported to the switched other recording medium.

A recording and playback device with a simple programmed recording method of a fifth aspect is the recording and playback device with a simple programmed recording method according to any one of the first to the fourth aspects, wherein the remaining amount detecting unit has a function of detecting whether an image of a person is recorded at the top of a recording file or not, and wherein the recording and playback device selectively displays the recorded image of a person as a background of the recording title.

According to a configuration of the fifth aspect, the remaining amount detecting unit has a function of detecting whether an image of a person is recorded at the top of a recording file or not, and a recorded image of a person is selectively displayed as a background of a recording title.

A recording and playback device with a simple programmed recording method of a sixth aspect is the recording and playback device with a simple programmed recording method according to any one of the first to the fifth aspects, further comprising the display unit, and wherein the recording and playback device displays the recording file recorded on the recording medium and the recording title.

According to a configuration of the sixth aspect, as the recording and playback device has a display unit, a recording file recorded on a recording medium and a recording title is displayed on the display unit.

### BRIEF DESCRIPTION OF THE DRAWINGS

FIG. 1 is a block diagram showing an outlined configuration of a television with a built-in DVD device which shows an example 1 of the present invention;

FIG. 2 is an oblique schematic view showing an overview of a television with a built-in DVD device and a remote control transmitting device of the present invention;

FIG. 3 is a table for showing examples of a method of decoding and identifying the recording mode which appear in a recording title according to the present invention;

FIG. 4 is a table for showing methods of decoding and identifying the recorded channel which appear in a recording title according to the present invention;

FIG. 5 is a table for showing methods of decoding and identifying the start time of recording which appear in a recording title according to the present invention;

FIG. 6 is a table for showing methods of decoding and identifying the recording date which appear in a recording title according to the present invention;

FIG. 7 is a flowchart for showing a procedure for setting programmed recording in the present invention;

FIG. 8 is a schematic diagram showing display examples of a recording titles list displayed as a menu screen in the present invention;

FIG. 9 is a schematic diagram showing an exemplary menu screen display for a viewer to confirm programmed recording selected from a displayed list in the present invention;

FIG. 10 is an oblique schematic view showing an overview of a complex device of a DVD device and a VTR device showing an example 2 of the present invention; and

FIG. 11 is a schematic diagram showing examples of various kinds of display of recording titles recorded by various kinds of recording and playback devices whose manufactures and models are different.

### DETAILED DESCRIPTION OF THE PREFERRED EMBODIMENTS

As mentioned above, the present invention enables a viewer to set programmed recording by sharing a recording medium among recording and playback devices whose manufacturers or models are different. In the description of examples below, an example 1 is a television with a built-in DVD (Digital Versatile Disk) device and an example 2 is a complex device of a DVD device and a VTR (Video Tape Recorder) device. The present invention will be described in detail with the embodiments.

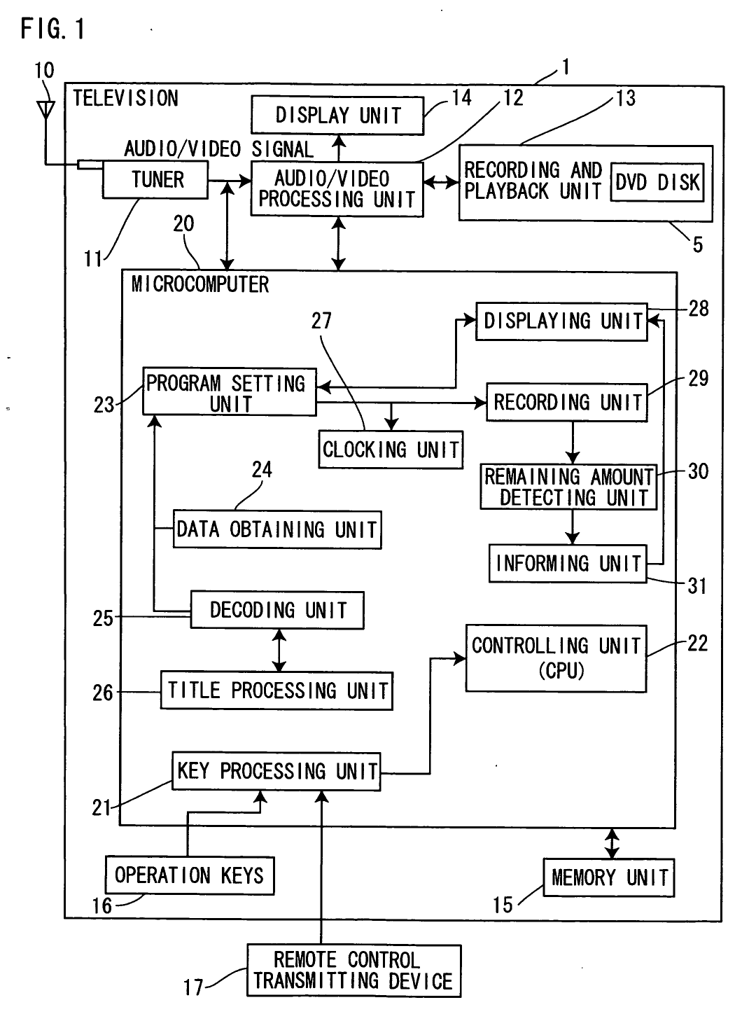

Examples as preferred embodiments for implementing the present invention will be described with reference to FIGS. 1 to 9 and FIG. 11 below. It is a matter of course that the present invention can be easily applied to examples other than those described as the examples without departing from the spirit of the invention.

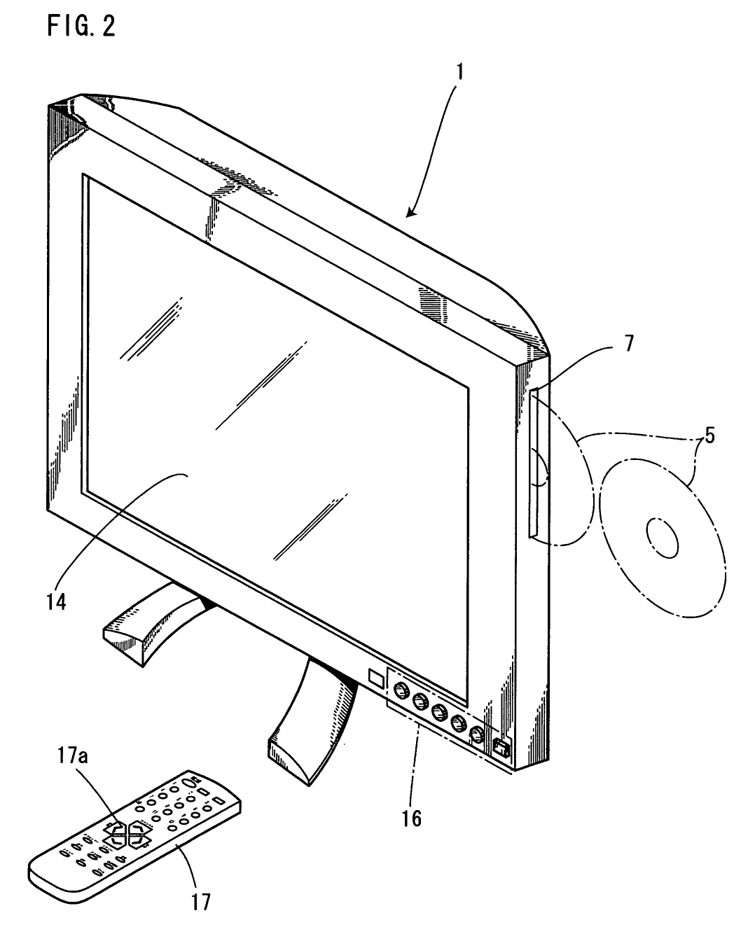

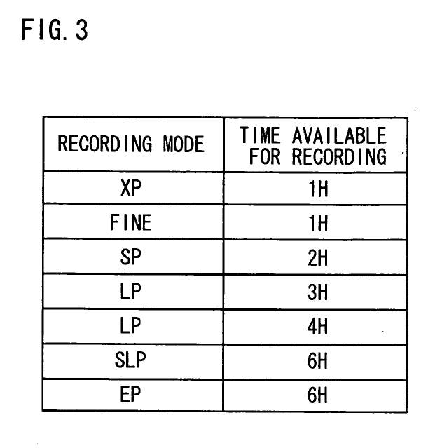

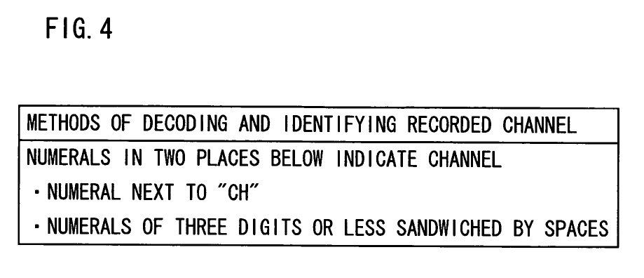

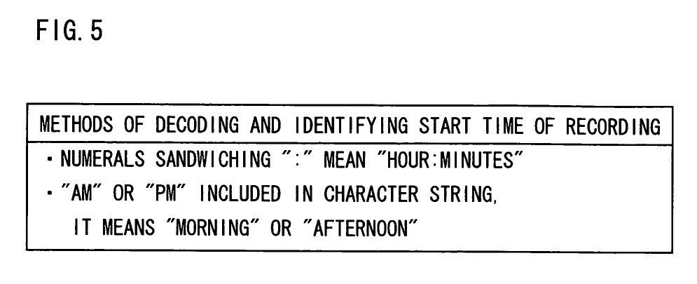

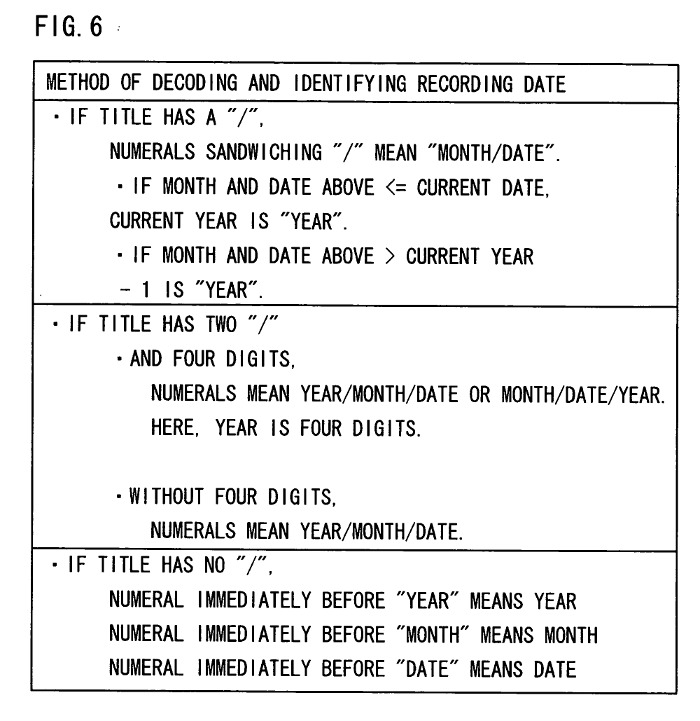

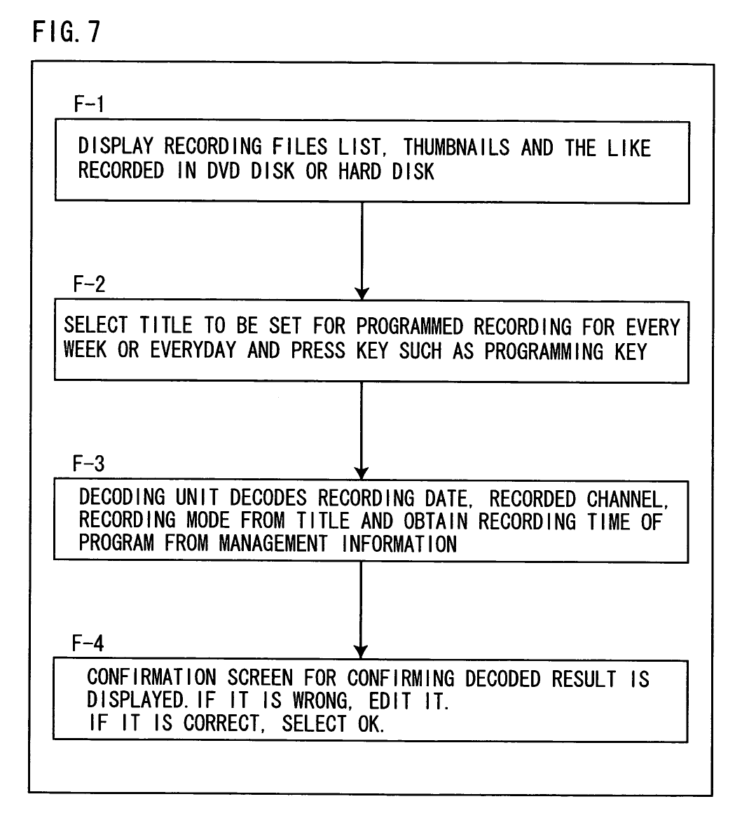

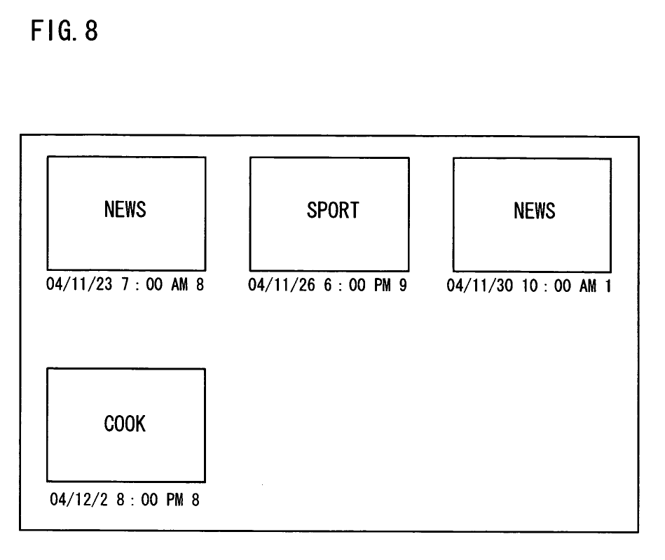

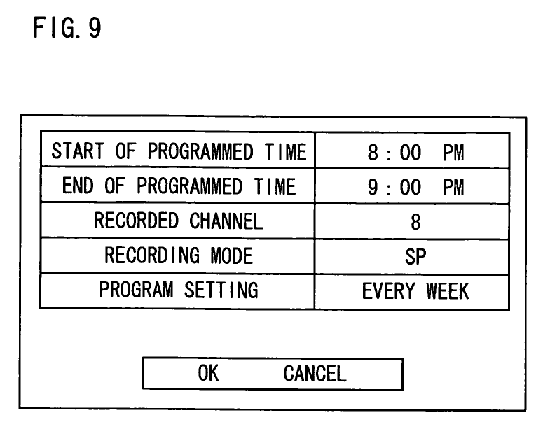

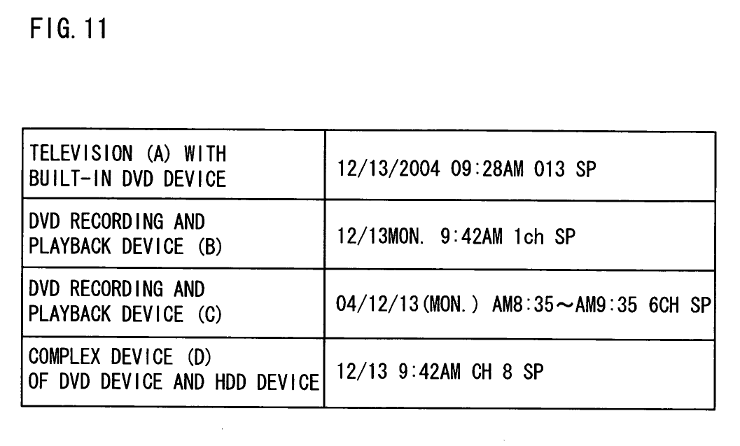

FIG. 1 is a block diagram showing an outlined configuration of a television with a built-in DVD device which shows an example 1 of the present invention. FIG. 2 is an oblique view showing an overview of a television with a built-in DVD device and a remote control transmitting device. FIG. 3 is examples of a method of decoding and identifying the recording modes which appear in a recording title shown in FIG. 11. FIG. 4 is methods of decoding and identifying the recorded channels which appear in a recording title. FIG. 5 is methods of decoding and identifying the start time of recording which appear in a recording title. FIG. 6 is methods of decoding and identifying the recording date which appear in a recording title. FIG. 7 is a flowchart for showing a procedure for performing programmed recording. FIG. 8 is display examples of a recording titles list displayed as a menu screen. FIG. 9 is an exemplary menu screen display for a viewer to confirm programmed recording selected from a displayed list. FIG. 11 is examples of various kinds of display of recording titles recorded by various kinds of recording and playback devices whose manufactures and models are different.

At first, overviews of a television 1 and a remote control transmitting device 17 in the example will be described with reference to FIG. 2. The television 1 has a display unit 14 on the front side with operation keys 16 below the display unit 14 and a disk loading section 7 on a side for carrying a DVD disk 5 into the television 1 when the DVD disk 5 is loaded. The remote control transmitting device 17 has operation keys 17a for indicating respective operation of the television 1. A viewer can set programmed recording or indicate to play a recorded recording file by operating the operation keys 16 and 17a.

Now, an outlined configuration of the television 1 with a built-in DVD device will be described with reference to FIG. 1. In the television 1, a tuner 11 selects a predetermined airwave from airwaves received by an antenna 10 and converts the airwave into audio/video signals. The audio/video signals converted by the tuner 11 are multiplexed and converted into analog by an MPEG IC, on which a circuit conforming to the MPEG (Moving Picture Experts Group) standard is mounted on an audio/video processing unit 12, and displayed on the display unit 14. When the audio/video signals are recorded on the DVD disk 5, the signals are encoded and digitized by the audio/video processing unit 12. When the audio/video signals are played from the DVD disk 5, the signals are converted into analog and multiplexed. The audio/video processing unit 12 has a not shown Chroma IC. The Chroma IC combines an OSD processed recording title (described later) with recording file video of a broadcast program so that the title and the video overlap each other and is displayed on the display unit 14. When a broadcast program is recorded on the DVD disk 5, a recording title corresponding to the recording file of the broadcast program is automatically created, and the recording file and the recording title are recorded on the DVD disk 5 by the recording and playback unit 13. When the broadcast program is played, the recording and playback unit 13 reads the recording file and the recording title out, and the audio/video signals of a recording file which are processed to be displayed by the audio/video processing unit 12 and character data including an OSD processed recording title are simultaneously displayed on the display unit 14. The television 1 has a microcontroller 20 which controls the respective parts. The television 1 also has a memory unit 15 made of EEPROM (Electrically Erasable PROM) which stores various kinds of data such as initial values of the microcontroller 20, channels and controlling data of the television 1, and also stores programmed recording programs including a recording title when the programmed recording programs are ported to the other recording medium. The microcontroller 20 has a key processing unit 21 for accepting input of various key code inputs from the remote control transmitting device 17 or the operation keys 16 provided on the body of the television 1, and determining the various key codes and passing them to a controlling unit 22. The controlling unit 22 controls by a CPU (Central Processing Unit) over operation of the television 1 or the respective processing units 21, 23 to 31 in the microcontroller 20 according to the determined various key codes. A data obtaining unit 24 obtains program data such as the EPG and passes it to a program setting unit 23. A title processing unit 26 creates a recording title based on the program data or recording when a program is recorded. The title processing unit 26 controls to pass data of a recording title read from the DVD disk 5 to a decoding unit 25 when program recording is set. A recording date, the start time of recording, the end time of recording, a recorded channel, a recording mode and the like included in a character string of data of a recording title read by the recording and playback unit 13 or data of a recording title created by the title processing unit 26, and a recording time read from management information recorded on the DVD disk 5 are decoded and converted into numerals by the decoding unit 25. Then, the program setting unit 23 obtains various kinds of data of a recording title and data of a recording time which were decoded and converted into numerals by the decoding unit 25, and sets programmed recording based on the recording title. The program setting unit 23 passes data of a recording time to a remaining amount detecting unit 30. When a viewer wants to check programmed recording program which is set to be programmed on a screen, the program setting unit 23 passes data of programmed recording setting to a displaying unit 28. The displaying unit 28 OSD processes the data as the data as a programmed recording setting screen when programmed recording is set, and as a program checking screen when a program is checked and displays the screen on the display unit 14. When a remaining amount for recording of the DVD disk 5 lacks, the displaying unit 28 performs OSD processing and controlling of the processing to display a screen for a viewer and inform the viewer of the lack under the control of informing unit 31. A clocking unit 27 controls to perform programmed recording by monitoring a time of set programmed recording as it counts a clock of the television 1. The clocking unit 27 performs counting necessary for the other control or process such as calculating or counting of various kinds of data both inside and outside the microcontroller 20. While the clocking unit 27 monitors a time of programmed recording, a recording unit 29 controls operation of the recording and playback unit 13 and causes the television 1 to perform recording such as usual recording or programmed recording. The remaining amount detecting unit 30 provided inside the microcontroller 20 calculates a remaining amount for recording of the current DVD disk 5 based on the recording time data obtained from the program setting unit 23. The remaining amount detecting unit 30 also detects whether an image of a person is recorded at the beginning of the recording file or not. The remaining amount detecting unit 30 passes the recording remaining amount data and detected data of an image of a person to the displaying unit 28, the recording unit 29 and the informing unit 31. When the remaining amount for recording lacks, the informing unit 31 which obtained the recording remaining amount data controls the displaying unit 28 to display the lack of the remaining amount for recording on the display unit 14 for informing a viewer of the lack. Then, the controlling unit 22 controls the disk loading section 7 of the recording and playback unit 13 shown in FIG. 2 to perform operation such as discharging the DVD disk 5 whose remaining amount for recording lacks. When an image of a person is detected at the beginning of a recording file, the informing unit 31 controls the displaying unit 28 to selectively display the image of a person on a menu screen which is displayed when program recording is set.

In this manner, the recording and playback unit 13 plays and reads a recording file previously recorded on the DVD disk 5 and a recording title corresponding to the recording file on the television 1. The audio/video processing unit 12 multiplexes and converts the digital signals into the analog signals so that audio/video signals of the recording file can be displayed on the screen of the display unit 14. For the recording title, a recording date, the start time of recording, the end time of recording, a recorded channel, a recording mode and the like included in a character string of recording title data and a recording time read from management information recorded on the DVD disk 5 are decoded and converted into numerals by the decoding unit 25. The converted respective numerals are set for programmed recording at the program setting unit 23. Such programmed recording setting is subject to OSD process at the displaying unit 28 and combined at the audio/video processing unit 12 and displayed on the display unit 14 when program recording is set or when programmed recording setting is checked. The top image of the program of the recording file to be played is displayed as a still image for a background of a screen for displaying the recording file to be selected, when programmed recording is set. If the displaying unit 28 detects that an image of a person is included at the top of the program, a still image of the image of a person is selectively used for a background of a menu screen. Accordingly, a viewer can easily recognize contents of a recording file on visual basis from a menu display of a recording title and the top of a recording file, i.e., the image of a person who impresses the contents of the program such as an MC or a performer which appears as a still image at the beginning of the program. Therefore, the viewer sets new programmed recording by checking the top of the recording file, i.e., a still image at the beginning of the program, or a still image of a person and a recording title displayed on the display unit 14.

Now, various displays of recording titles recorded by various recording and playback devices whose manufacturers and models are different will be described with reference to FIG. 11. The recording title recorded by a television (A) 1 with a built-in DVD device is displayed as “12/13/2004 09:28 AM 013 SP”. The recording title recorded by a DVD recording and playback device (B), which is a single machine, is displayed as “12/13 Monday 9:42 AM 1ch SP”. That similarly recorded by a DVD recording and playback device (C) is displayed as “04/12/13 (Mon.) AM8:35-AM9:35 6CH SP”. That recorded by a complex device (D) of a DVD device and an HDD (Hard Disk Drive) device is displayed as “12/13 9:42 AM CH 8 SP”. As recording and playback devices differ in those manufacturers and models, a method of displaying a recording title recorded on various kinds of recording media such as a DVD disk 5 or an HDD disk as well as a VTR tape other than the display examples also differs. It is difficult to recognize and identify the displaying method from such character strings.

Methods of decoding and identifying a character string of a recording title which differs in displaying method due to different manufactures and models will be described with reference to FIGS. 3 to 6. A recording time is set with a recording time recorded as the end time of recording. As for a recording title for which only a start time of recording is displayed, the end time of recording is calculated from the start time of recording and a recording time. As another recording time calculating method, a decoding and identifying method of a recording mode in a character string of each recording title of the FIG. 11 can be a method of calculating a time available for recording on a DVD-R, RW disk of 4. 7 GB, for example, as shown in FIG. 3. Displays such as “XP” and “FINE” mean that they are available for recording an hour, a display such as “SP” means that it is available for recording two hours, a display such as “LP” means that it is available for recording three or four hours, and a display such as “SLP” and “EP” mean that they are available for recording six hours. Therefore, the recording title recorded by the television (A) 1 with a built-in DVD device in FIG. 11 is displayed as “12/13/2004 09:28 AM 013 SP” and the DVD disk 5 of the recording title shows that it is available for recording two hours.

Now, methods of decoding and identifying a recorded channel will be described with reference to FIG. 4. The first method is that the numeral next to “CH” or “ch” shows a recorded channel. The second method is that numerals of three digits or less sandwiched by spaces show a recorded channel. In the recording title displays shown in FIG. 11, a recording title recorded by the television (A) 1 with a built-in DVD device is displayed as “12/13/2004 09:28 AM 013 SP”. As “013” in the recording title is sandwiched by spaces, it corresponds to the first identifying method and indicates the channel 13. A recording title recorded by the DVD recording and playback device (B), which is a single machine, is displayed as “12/13 Monday 9:42 AM 1ch SP”, and indicates the channel 1. Similarly, that recorded by the DVD recording and playback device (C) is displayed as “04/12/13 (Mon.) AM8:35-AM9:35 6CH SP”, and indicates the channel 6, and that recorded by the complex device (D) of a DVD device and an HDD device is displayed as “12/13 9:42 AM CH8 SP”, and indicates the channel 8.

Now, methods of decoding and identifying the start time of recording will be described with reference to FIG. 5. The first method is that the numerals sandwiching “:” mean “hour:minutes”, respectively. The second method is that if “AM” or “PM” included in a character string of the recording title, it means “morning” or “afternoon”. A recording title recorded by the television (A) 1 with a built-in DVD device is displayed as “12/13/2004 09:28 AM 013 SP”, with “09:28” indicating the starting time of recording and the following “AM” indicating “morning”. That is to say, it indicates that the recording file recorded by the television (A) 1 with a built-in DVD device is recorded from 9:28 in the morning. Similarly, a recording title recorded by the DVD recording and playback device (C) is displayed as “04/12/13 (Mon.) AM8:35-AM9:35 6CH SP”, which indicates that the recording started at 8:35 in the morning. The following “-AM 9:35” indicates that the recording ended at 9:35 in the morning.

Now, methods of decoding and identifying the recording date will be described with reference to FIG. 6. The first method is that if the recording title has a “/”, the numerals sandwiching the “/” indicate “month/date”, respectively. If the numerals indicating the “month/date” are the same as the current date or earlier than the current date as a calendar day, “the current year” is the “year” of the recording date. If the numerals indicating the “month/date” are later than the current date as a calendar day, “the current year−1” is the “year” of the recording date. For example, the recording title recorded by the complex device (D) of a DVD device and an HDD device is displayed as only “12/13 9:42 AM CH 8 SP”, which indicates that the recording was done on December 13 without indicating the year of the recording. If the current date is Dec. 20, 2004, December 13 is earlier than December 20 as a calendar day; thus, it indicates that the recording was done on Dec. 13, 2004. If the current date is Jan. 20, 2005, the recording date December 13 is later than the current date January 20 as a calendar day; thus, it indicates the recording was done in 2004, which is the current year 2005 minus 1.

The second method is that if the recording title has two “/” and four digits, it indicates “year/month/date” or “month/date/year”, with the four digits indicating the year. If the recording title does not include four digits, it indicates “year/month/date”. For example, the recording title recorded by the television (A) 1 with a built-in DVD device is displayed as “12/13/2004 09:28 AM 013 SP”, with the numerals displayed as “12/13/2004” indicating that the recording was done on Dec. 13, 2004. The recording title recorded by the DVD recording and playback device (C) is displayed as “04/12/13 (Mon.) AM8:35-AM9:35 6CH SP”, indicating that the recording was done on Monday, Dec. 13, 2004.

The third method is that if the recording title has no “/”, the numeral immediately before “year” means “year”, the numeral immediately before “month” means “month”, and the numeral immediately before “date” means “date”. For example, the display of “2004, December 13” means that the recording was done on Dec. 13, 2004.

Now, a procedure of performing programmed recording will be described by using a flowchart of FIG. 7, display examples of a recording titles list of FIG. 8, and an exemplary menu screen display for a viewer to confirm programmed recording of FIG. 9. Here, a viewer is inserting the DVD disk 5, on which a plurality of broadcast programs are recorded by the other DVD recording and playback device (not shown), into the television 1 shown in FIG. 2. At the noon of December 3 (Fri.), the viewer presses an operation key 17a on the remote control transmitting device 17 shown in FIG. 2 to indicate the device to display a list of recording files recorded on the DVD disk 5 at F-1 shown in FIG. 7 in order to set programmed recording of a serial cooking show in a plurality of recording files recorded on the DVD disk 5. Then, the display unit 14 of the television 1 shows a list of a plurality of recording files showing a plurality of recording files recorded by the other DVD recording and playback device as shown in FIG. 8. On this list, a still image at the top of each program “NEWS”, “SPORT”, “NEWS”, “COOK” is displayed in the form of a Thumbnail or the like in the order of recording. Under the respective still images, “04/11/23 7:00 AM 8”, “04/11/26 6:00 PM 9”, “04/11/30 10:00 AM 1”, “04/12/2 8:00 PM 8” and character strings of the recording titles are displayed.

When the viewer then presses the operation key 17a on the remote control transmitting device 17 or a programming key of operation keys 16 (not shown) to select a recording title to set for programmed recording among the still images and recording titles under the thumbnails shown in FIG. 8 at F-2, details of the recording title selected by the viewer are displayed as shown in FIG. 9. Specifically, when the viewer selects “COOK, 04/12/2 8:00 PM 8” from the displayed list shown in FIG. 8 and presses the programming key to indicate set programmed recording, the decoding unit 25 decodes “recording date”, “start time of recording”, “end time of recording”, “recorded channel”, “recording mode” from a character string of the recording title corresponding to the recording file of the “COOK, 04/12/2 8:00 PM 8”, which was recorded by the other DVD recording and playback device, obtains “recording time” from management information recorded on the DVD disk 5 at F-3. The program confirmation screen shown in FIG. 9 is displayed on the display unit 14 at F-4. The program confirmation screen displays that “start of the programmed time” is 8:00 PM, “end of the programmed time” is 9:00 PM, for example, which is calculated from the recording time, “recorded channel” is channel 8, “recording mode” is SP, and “program setting” is every week. If the viewer finds the display of the program confirmation screen correct, the viewer selects “OK” from “OK Cancel” to set programmed recording. If the viewer selects a wrong recording title and a “NEWS” program is displayed, the viewer reselects “COOK” shown in FIG. 8. If the viewer finds an error in the screen display such as “recorded channel” is displayed as channel 9, or if the viewer wants to change the setting to the other programmed recording setting, the viewer can edit the setting such as to correct the channel 9 to channel 8 by operating the operation key 17a on the remote control transmitting device 17, for example. In this description on “recording time”, management information recorded on the DVD disk 5 is used for the “recording time” as mentioned above, though, the start time of recording and the end time recorded on the recording title or a recording time recorded in the recording title can be used.

This cooking show was first recorded from 8:00 PM of December 2 (Thu.). When the viewer sets programmed recording for the show from the next serial at the noon of December 3 (Fri.), recording “every week” is displayed in the “program setting” entry in FIG. 9. This is because the data obtaining unit 24 obtains information that the recording file, which was recorded from 8:00 PM on December 2 (Thu.), is the second serial of the whole fourteen serials and that the program is broadcast from 8:00 PM every Thursday from the EPG or the like. If such information is not obtained from the EPG or the like at this moment, a Popup Menu is displayed for the “program setting” entry for the viewer to select from “everyday, every week” or the recording date and time as the viewer obtains program information that the program is broadcast “every week” from a program list displayed on newspapers or magazines. Then, the viewer selects an item on the Popup Menu by operating the remote control transmitting device 17. As the cooking show is serial that is broadcast every week, the viewer selects “every week” from “everyday” and “every week” to set programmed recording for every week. On the program confirmation screen displayed in response to the selection, the viewer checks that “start of programmed time is 8:00 PM”, “end of programmed time is 9:00 PM”, “recorded channel is channel 8”, “recording mode is SP” and “programmed recording is for every week”. If the viewer finds the recording title of the recording file the viewer wants to program correct, the viewer selects “OK”. Accordingly, programmed recording is set for the cooking show based on the recording title decoded and converted into numerals by the decoding unit 25. The programmed recording is automatically done from 8:00 PM on December 9 (Thu.), the next serial, December 16 (Thu.), the subsequent serial, and the serials thereafter as the clocking unit 27 shown in FIG. 1 monitors the time of the programmed recording.

A method of automatically performing programmed recording a rebroadcast program whose original broadcast was missed will be described. The recording title of the cooking show which is set for programmed recording from the next serial according to the procedure shown in FIG. 7, “COOK, 04/12/2 8:00 PM 8” is a program of fourteen serials and not the first serial but the second serial of the fourteen serials as mentioned above. The program broadcast on November 25 (Thu.) was in the previous week of December 2 (Thu.) when the program is first recorded is the first of the fourteen serials and the viewer did not record the first of the serials. The viewer sets programmed recording for the cooking show from the next serial by the procedure shown in FIG. 7 at the noon of December 3 (Fri.). The data obtaining unit 24 shown in FIG. 1 obtains program data that the cooking show is serial which is to be broadcast for fourteen times starting at November 25 (Thu.) as the first serial from the EPG or the like. The program setting unit 23 determines that the cooking show is serial which is to be broadcast for fourteen times. If program setting unit 23 determines that the first serial of the fourteen serials broadcast on November 25 has not been recorded, it detects “rebroadcast of the first serial of the fourteen serials” by using the EPG data, sets programmed recording for the rebroadcast program to automatically record the rebroadcast program. From program data by the EPG indicating that the cooking show is rebroadcast at 11:00 AM on Saturday of the next week of the original broadcast, programmed recording is automatically set for the rebroadcast of the first serial of the fourteen serials from 11:00 AM on December 4 (Sat.) and the program is automatically recorded. In the recording file, the first serial of the cooking show which was recorded at the rebroadcast of the program is November 25 (Thu.), followed by December 2 (Thu.), December 9 (Thu.), December 16 (Thu.) and so on, which are rebroadcast on December 4 (Sat.), December 11 (Sat.), December 18 (Sat.) and so on. Therefore, the cooking show is recorded on the DVD disk 5 in the order of recording: December 2 (second serial), December 4 (rebroadcast of the first serial), December 9 (third serial), December 16 (fourth serial). The recording file recorded in this order is sorted by the control unit 22 in the order of the rebroadcast of the first serial, the second serial, the third serial, and the fourth serial. When the viewer plays and views the recording file of the serial, the cooking show is played in the original broadcast order and displayed on the display unit 14 of the television 1.

Now, operation taken when a remaining amount for recording of the DVD disk 5 which is inserted in the television 1 lacks will be described. When programmed recording for the abovementioned cooking show is set but the remaining amount for recording of the DVD disk 5 lacks such that the programmed recording is set for the cooking show which is broadcast for an hour but the DVD disk 5 is available for recording for thirty minuets, the embodiment informs a viewer of the lack in the manner shown below. Detecting and informing of the lack of remaining amount for recording by the DVD disk 5 will be described with reference to FIG. 1. As mentioned above, the second serial of the cooking show is recorded on the DVD disk 5. When the recording and playback unit 13 plays and reads the recording file and the recording title corresponding to the recording file of the cooking show, recording time data is read from management information recorded on the DVD disk 5, and the decoding unit 25 decodes the read recording title and the recording time and converts them into numerals. The remaining amount detecting unit 30 calculates a remaining amount for recording of the DVD disk 5 from the recording time data and the recording mode of the recording title which is set for programmed recording. If the remaining amount for recording lacks, the informing unit 31 controls the display unit 28 to display characters prompting the viewer to change the DVD disk 5 to a new one on the display unit 14. In the television 1, according to informing indication outputted from the informing unit 31, the control unit 22 causes the disk loading section 7 shown in FIG. 2 in the recording and playback unit 13 to discharge the DVD disk 5 which lacks a remaining amount for recording and prompt the viewer to change the DVD disk 5 to another one. When the DVD disk 5 is changed to another one and a serial is recorded, the copy of the programmed recording program such as the recording title of the programmed recording which was recorded on the previous DVD disk 5 is stored in the memory unit 15 and ported to another DVD disk 5 which is inserted in exchange for the previous DVD disk 5. The recording file is recorded on the newly inserted DVD disk 5 based on the copy. Therefore, the following serials of the cooking show will be automatically performed based on the programmed recording program such as the ported recording title.

As mentioned above, according to the first example, the television 1 with a built-in DVD device, which is a recording and playback device of the present invention, can make programmed recording from the next serial for serials which will be broadcast everyday or every week by using a recording title of the DVD disk 5, which is a recording medium recording the recording file of the program. Therefore, the decoding unit 25 can decode the recording title recorded on the DVD disk 5 by a single machine of a DVD recording and playback device, a complex device of a DVD device and an HDD device, a complex device 2 of a DVD device and a VTR device, and a television 1 with a built-in DVD device whose manufactures and models are different. Thus, programmed recording from the next serial can be set to the recording medium such as a DVD disk 5 on which the serials are recorded by the other recording and playback device. This improves usability for a viewer as the viewer is not limited to use a particular recording and playback device. As programmed recording from the next serial can be set by using the recording title of the recording file recorded on the recording medium such as a DVD disk 5, the viewer is relieved of complicated operating procedure such as inputting details required for setting a new programmed recording including a recorded channel and a start date and time of recording with the operation keys 16 or the remote control transmitting device 17. As such, the recording and playback device enables anyone to easily set programmed recording at home where generally viewers of any age group often use the device. Video of a recording file recorded on the recording medium such as the DVD disk 5 and the recording title are also displayed as a menu screen when a viewer sets programmed recording. This can reduce the number of selection errors such as selecting a wrong recording title in operating the programmed recording or setting errors such as setting a wrong recorded channel or a wrong start time of recording, even if a plurality of recording files are recorded on the recording medium such as the DVD disk 5. Programmed recording from the next serial can be set by using the recording title which is automatically created and recorded on the recording medium such as the DVD disk 5 at the end of recording. If the history of setting programmed recording is left and used in setting a new programmed recording, memory capacity of the memory unit 15 may not lack. Therefore, memory capacity needs not be added or another region needs to be reserved in memory, which reduces load in controlling of the microcontroller 20.

If programmed recording is set from the next serial but a previously broadcast serial is missed being recorded, rebroadcast of the missed serial can be automatically recorded by using program data such as the EPG. This improves usability of viewers.

If a remaining amount for recording of the recording medium such as the DVD disk 5 which is inserted to record a program lacks in performing programmed recording, the recording and playback device can display and inform of the lack of a remaining amount for recording on the display unit 14 of the television 1 or the other display unit such as a monitor, further operate the disk loading section 7 to discharge the DVD disk 5 and prompt a viewer to change the recording medium such as the DVD disk 5 to another one which fills the remaining amount for recording, and also can port a programmed recording program such as a recording title to the new DVD disk 5. This relieves the viewer of complicated operation such as setting programmed recording to the new DVD disk 5.

When a viewer selects a recording title in setting programmed recording, the viewer can easily recognize contents of the program from a menu display of the recording title and an image of a person who impresses the contents of the program such as an MC or a performer appears at the beginning of the program on visual basis. This can reduce the number of errors in selecting or setting a recording title.

The recording and playback device of the example 1 has been described in the case of the television 1 with a built-in DVD device which is a recoding and playback device with the display unit 14 as an example of a recording and playback device which includes a tuner 11 and enables programmed recording and playing. As such, the device needs not to externally connect with a display device such as a separate monitor. The device enables a viewer to easily set programmed recording by using a menu screen including recording files and recording titles displayed on the display unit 14.

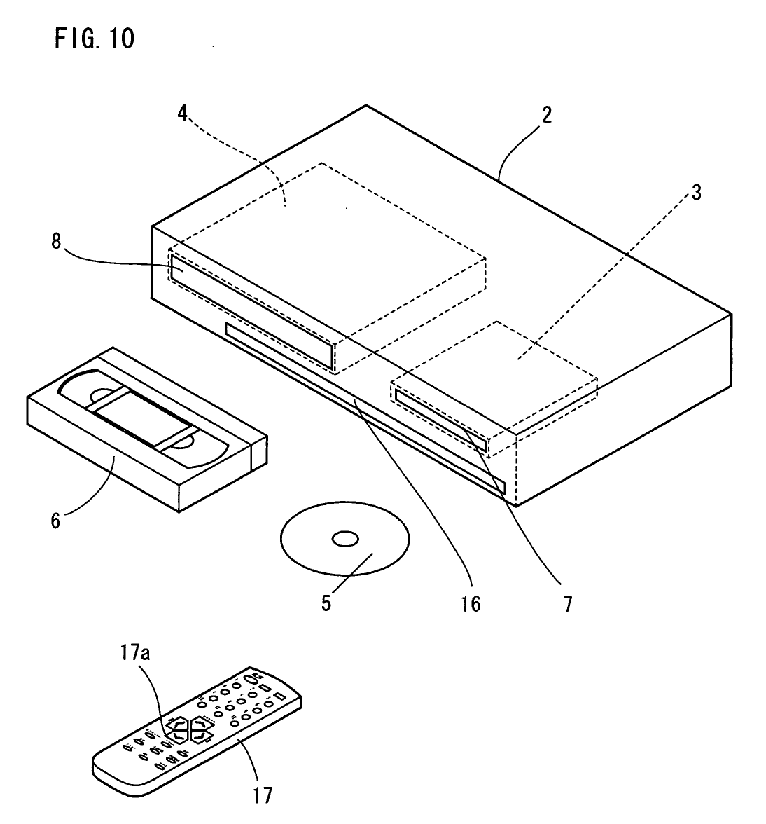

Now, an example 2 of the present invention will be described with reference to FIG. 10. FIG. 10 is an oblique schematic view showing an overview of a complex device of a DVD device and a VTR device. A DVD disk 5 and a VTR tape 6 can be inserted into/discharged from the complex device 2 at a disk loading section 7 which is placed in the front of the DVD device 3 and a cassette loading section 8 which is placed in the front of the VTR device 4. The complex device 2 also has operation keys 16 below the sections 7 and 8, as well as a remote control transmitting device 17. A viewer can operate the operation keys 16 or the remote control transmitting device 17 to indicate recording, playing or the like. The complex device 2 also has the same programmed recording function as that of the television 1 of the example 1 but a display unit 14 such as a monitor. Therefore, the complex device 2 is connected with the other display unit such as a monitor (not shown).

Operation taken when a remaining amount for recording lacks in the complex device 2 will be described. Programmed recording is set for the cooking show as mentioned above according to the procedure of FIG. 7 in the complex device 2, but a remaining amount for recording lacks in DVD disk 5 which is inserted in the complex device 2. When a viewer sets programmed recording for recording a cooking show which is broadcast for an hour but the DVD disk 5 is only available for recording thirty minuets, the complex device 2 performs programmed recording by changing the recording media from the DVD disk 5 to a VTR tape 6. Detecting and informing of the remaining amount for recording of the DVD disk 5 will be described with reference to FIG. 1. The recording file of the second serial cooking show is previously recorded on the DVD disk 5 in the complex device 2 of a DVD device 3 and a VTR device 4. The recording and playback unit 13 shown in FIG. 1 reads the recording title corresponding to the recorded file. The recording time data is read from management information recorded on the DVD disk 5, and decoded and converted into numerals by the decoding unit 25. The remaining amount unit 30 calculates a remaining amount for recording of the DVD disk 5 from the recording time data, the recording mode or the like of the recording title which is set for programmed recording. If the remaining amount for recording lacks, the informing unit 31 controls the displaying unit 28 to display characters prompting a viewer to change the DVD disk 5 to a new one on an externally connected display unit such as a monitor, which corresponds to the display unit 14, while the DVD disk 5 which lacks in a remaining amount for recording is being discharged. If the viewer changes the DVD disk 5 to a new one in response to the prompt, the programmed recording program such as the recording title of programmed recording is ported to the new DVD disk 5 and the program is going to be recorded thereon. If the viewer does not change the DVD disk 5 to a new one, the control unit 22 stops the DVD device 3 to perform the programmed recording in response to the informing indication outputted from the informing unit 31 and controls the VTR tape 6 to substitute the VTR device 4 and perform the programmed recording in the complex device 2. If the VTR device 4 is substituted for the DVD device 3 to perform the programmed recording, a display device such as a monitor (not shown) or the like can display information that the VTR device 4 substitutes for the DVD device 3 to perform the programmed recording. By looking at this, the viewer can recognize that a remaining amount for recording of the DVD disk 5 lacks and that the recording started as the VTR tape 6 substitutes for the DVD device 5. If serials are recorded across the DVD disk 5 and the VTR tape 6, the programmed recording program such as the recording title of the programmed recording recorded on the DVD disk 5 is copied and stored on the memory unit 15. The programmed recording program is ported to the substituting VTR tape 6. Accordingly, the following programmed recording of the cooking show is automatically performed on the VTR tape 6 based on the programmed recording program such as the ported recording title.

As mentioned above, the example 2 is a recording and playback device with a plurality of recording and playback units 13 and a complex device 2 of a DVD device 3 and a VTR device 4. The complex device 2 has a recording and playback unit 13 for a DVD and a recording and playback unit 13 for a VTR. The VTR tape 6, one of the recording media, substituting for the DVD disk 5, the other recording medium, due to the lack of a remaining amount for recording of the DVD disk 5 has the recording title and the data which is set for programmed recording from the next serial ported. If only the VTR tape 6, one of the recording medium, is inserted into the complex device 2, the broadcast program for which programmed recording is set can be automatically recorded on the VTR tape 6.

Although the example has been described in detail, various modifications can be made within the spirit of the present invention. For example, the recording and playback device is not limited to the television 1 with a built-in DVD device or the complex device 2 of the DVD device 3 and the VTR device 4. The recording and playback device can be any device if only the device can perform programmed recording and playback with a tuner 11 such as a single device of a DVD recording and playback device or an HDD recording and playback device (not shown) and a complex device such as a DVD device 3 and an HDD device. The functions of respective processing units 21 to 31 in the microcontroller 20 in the configuration of the recording and playback device are also not limited to the example. The functions can be selected as required such as modified if they can be divided or integrated among the other processing units 21 to 31 in consideration of a design or usability.

According to the first aspect, new programmed recording can be set by using a recording title in a recording medium which records a recording file of serials. Even if the serials are recorded by the other recording and playback devices whose manufacturers and models are different, the decoding unit can decode a recording title recorded on the recording medium, enabling a viewer to set new programmed recording from the recording medium recorded by the other recording and playback device. This improves usability of a viewer as the viewer is not limited to use a particular recording and playback device. This can also eliminate a complicated operating procedure such as operating operation keys or a remote control transmitting device to set details including a recorded channel and start time of recording. Therefore, the recording and playback device enables anyone to easily set programmed recording at home where generally viewers of any age group often use the device. Video of a recording file recorded on the recording medium and a recording title are displayed as a menu screen when a viewer sets programmed recording. This can reduce the number of selection errors such as selecting a wrong recording title in operating programmed recording or setting errors such as setting a wrong recorded channel or a wrong start time of recording, even if the recording medium records a plurality of recording files. As programmed recording of following serials can be set by using a recording title which is automatically created at the end of recording and recorded on a recording medium, memory capacity of a memory unit may not lack. Thus, memory capacity needs not be added or another region needs not be reserved in memory. This can reduce load on microcontroller control.

According to the second aspect, if a program among programs set for new programmed recording is missed being recorded, the rebroadcast program can be automatically recorded by using program data such as the EPG. This can improve usability of a viewer.

According to the third aspect, if a remaining amount for recording of a recording medium inserted for programmed recording lacks when programmed recording is performed, the remaining amount detecting unit detects the lack and the informing unit informs the lack of the remaining amount for recording to prompt a viewer to change the recording medium to a new one.

According to the fourth aspect, as the recording and playback device has a plurality of recording and playback units, and if a remaining amount of a recording medium on which a program is recorded by the recording and playback unit lacks, the recording medium is switched to any of the other recording media and recording starts, and the recording title and a programmed recording program which is set for programmed recording anew are ported to the switched other recording medium. Therefore, the recording and playback device can automatically record a broadcast program based on the ported programmed recording program if only any of the other recording media to be switched is previously inserted into the recording and playback device.

According to the fifth aspect, a viewer can easily recognize and determine contents of a program of a recording file on visual basis from a recording title and an image of a person which impresses the contents of the program such as an MC or a performer who appears at the beginning of the broadcast program, when the viewer selects a recording title in setting the programmed recording. This can reduce the number of errors in selecting a recording title or setting the recording date and time.

According to the sixth aspect, as the recording and playback device has a display unit, the recording and playback device needs not to be connected with a separate display unit, and enables a viewer to easily set programmed recording by using a recording file and a recording title displayed on the display unit.

What is claimed is:

1. A recording and playback device which can receive airwaves, convert the airwaves into audio/video signals which can be displayed and display the audio/video signals on a display unit, convert the audio/video signals which can be displayed into audio/video data which can be recorded and played and record and replay the audio/video data on a recording medium by a recording and playback unit, wherein the recording and playback device creates a recording title and displays the recording title on the display unit, and sets programmed recording based on the displayed recording title and records a program by monitoring a broadcast time of the program corresponding to a programmed recording program set from the recording title, comprising a decoding unit for decoding date of recording, start time of recording, end time of recording, recorded channel, recording mode and the like included in a character string of a recording title from a recording file and the recording title of the broadcast program read out from the recording medium into a microcontroller provided in the recording and playback device and converting the date of recording, the start time of recording, the end time of recording, the recorded channel, the recording mode and the like into numerals, wherein a program setting unit provided in the microcontroller converts video of a recording title recorded on the recording medium and the recording title into numerals and sets new programmed recording.

2. The recording and playback device with a simple programmed recording method according to claim 1, wherein the decoding unit decodes data on rebroadcast program obtained from the EPG or the like and a character string of a recording title of the rebroadcast program and converts the data and the character string into numerals, wherein the programmed setting unit automatically records programs by setting programmed recording of a rebroadcast program based on each of the converted numerals, and wherein the program setting unit sorts recorded programs into an order the programs originally broadcast for playing a program which is missed being recorded in the order.

3. The recording and playback device with a simple programmed recording method according to claim 1, wherein the microcontroller comprises a remaining amount detecting unit for calculating remaining amount of a current recording medium based on recording time data obtained from the program setting unit and an informing unit for informing a lack of the remaining amount, wherein the lack of the remaining amount is informed when the remaining amount lacks.

4. The recording and playback device with a simple programmed recording method according to claim 2, wherein the microcontroller comprises a remaining amount detecting unit for calculating remaining amount of a current recording medium based on recording time data obtained from the program setting unit and an informing unit for informing a lack of the remaining amount, wherein the lack of the remaining amount is informed when the remaining amount lacks.

5. The recording and playback device with a simple programmed recording method according to claim 1, further comprising a plurality of recording and playback units, wherein if a remaining amount of a recording medium recorded at the recording and playback unit lacks, the recording medium is switched to any of the other recording media and recording is started, and the recording title and a new programmed recording program are ported to the other recording medium.

6. The recording and playback device with a simple programmed recording method according to claim 2, further comprising a plurality of recording and playback units, wherein if a remaining amount of a recording medium recorded at the recording and playback unit lacks, the recording medium is switched to any of the other recording media and recording is started, and the recording title and a new programmed recording program are ported to the other recording medium.

7. The recording and playback device with a simple programmed recording method according to claim 3, further comprising a plurality of recording and playback units, wherein if a remaining amount of a recording medium recorded at the recording and playback unit lacks, the recording medium is switched to any of the other recording media and recording is started, and the recording title and a new programmed recording program are ported to the other recording medium.

8. The recording and playback device with a simple programmed recording method according to claim 4, further comprising a plurality of recording and playback units, wherein if a remaining amount of a recording medium recorded at the recording and playback unit lacks, the recording medium is switched to any of the other recording media and recording is started, and the recording title and a new programmed recording program are ported to the other recording medium.

9. The recording and playback device with a simple programmed recording method according to claim 1, wherein the remaining amount detecting unit has a function of detecting whether an image of a person is recorded at the top of a recording file or not, and wherein the recording and playback device selectively displays the recorded image of a person as a background of the recording title.

10. The recording and playback device with a simple programmed recording method according to claim 2, wherein the remaining amount detecting unit has a function of detecting whether an image of a person is recorded at the top of a recording file or not, and wherein the recording and playback device selectively displays the recorded image of a person as a background of the recording title.

11. The recording and playback device with a simple programmed recording method according to claim 3, wherein the remaining amount detecting unit has a function of detecting whether an image of a person is recorded at the top of a recording file or not, and wherein the recording and playback device selectively displays the recorded image of a person as a background of the recording title.

12. The recording and playback device with a simple programmed recording method according to claim 4, wherein the remaining amount detecting unit has a function of detecting whether an image of a person is recorded at the top of a recording file or not, and wherein the recording and playback device selectively displays the recorded image of a person as a background of the recording title.

13. The recording and playback device with a simple programmed recording method according to claim 5, wherein the remaining amount detecting unit has a function of detecting whether an image of a person is recorded at the top of a recording file or not, and wherein the recording and playback device selectively displays the recorded image of a person as a background of the recording title.

14. The recording and playback device with a simple programmed recording method according to claim 6, wherein the remaining amount detecting unit has a function of detecting whether an image of a person is recorded at the top of a recording file or not, and wherein the recording and playback device selectively displays the recorded image of a person as a background of the recording title.

15. The recording and playback device with a simple programmed recording method according to claim 7, wherein the remaining amount detecting unit has a function of detecting whether an image of a person is recorded at the top of a recording file or not, and wherein the recording and playback device selectively displays the recorded image of a person as a background of the recording title.

16. The recording and playback device with a simple programmed recording method according to claim 8, wherein the remaining amount detecting unit has a function of detecting whether an image of a person is recorded at the top of a recording file or not, and wherein the recording and playback device selectively displays the recorded image of a person as a background of the recording title.

17. The recording and playback device with a simple programmed recording method according to claim 1, further comprising the display unit, and wherein the recording and playback device displays the recording file recorded on the recording medium and the recording title.

18. The recording and playback device with a simple programmed recording method according to claim 2, further comprising the display unit, and wherein the recording and playback device displays the recording file recorded on the recording medium and the recording title.

19. The recording and playback device with a simple programmed recording method according to claim 3, further comprising the display unit, and wherein the recording and playback device displays the recording file recorded on the recording medium and the recording title.

20. The recording and playback device with a simple programmed recording method according to claim 4, further comprising the display unit, and wherein the recording and playback device displays the recording file recorded on the recording medium and the recording title.

21. The recording and playback device with a simple programmed recording method according to claim 5, further comprising the display unit, and wherein the recording and playback device displays the recording file recorded on the recording medium and the recording title.

22. The recording and playback device with a simple programmed recording method according to claim 6, further comprising the display unit, and wherein the recording and playback device displays the recording file recorded on the recording medium and the recording title.

23. The recording and playback device with a simple programmed recording method according to claim 7, further comprising the display unit, and wherein the recording and playback device displays the recording file recorded on the recording medium and the recording title.

24. The recording and playback device with a simple programmed recording method according to claim 8, further comprising the display unit, and wherein the recording and playback device displays the recording file recorded on the recording medium and the recording title.

25. The recording and playback device with a simple programmed recording method according to claim 9, further comprising the display unit, and wherein the recording and playback device displays the recording file recorded on the recording medium and the recording title.

26. The recording and playback device with a simple programmed recording method according to claim 10, further comprising the display unit, and wherein the recording and playback device displays the recording file recorded on the recording medium and the recording title.

27. The recording and playback device with a simple programmed recording method according to claim 11, further comprising the display unit, and wherein the recording and playback device displays the recording file recorded on the recording medium and the recording title.

28. The recording and playback device with a simple programmed recording method according to claim 12, further comprising the display unit, and wherein the recording and playback device displays the recording file recorded on the recording medium and the recording title.

29. The recording and playback device with a simple programmed recording method according to claim 13, further comprising the display unit, and wherein the recording and playback device displays the recording file recorded on the recording medium and the recording title.

30. The recording and playback device with a simple programmed recording method according to claim 14, further comprising the display unit, and wherein the recording and playback device displays the recording file recorded on the recording medium and the recording title.

31. The recording and playback device with a simple programmed recording method according to claim 15, further comprising the display unit, and wherein the recording and playback device displays the recording file recorded on the recording medium and the recording title.

32. The recording and playback device with a simple programmed recording method according to claim 16, further comprising the display unit, and wherein the recording and playback device displays the recording file recorded on the recording medium and the recording title.
